(19) United States
(12) Patent Application Publication
(10) Pub. No.: US 2019/0134849 A1
(43) Pub. Date: May 9, 2019

(54) CONCRETE FAUCET

(71) Applicant: Delta Faucet Company, Indianapolis, IN (US)

(72) Inventors: Michael Scot Rosko, Greenwood, IN (US); Thad J. Eads, Urbana, IN (US)

(21) Appl. No.: 16/021,346

(22) Filed: Jun. 28, 2018

Related U.S. Application Data
(60) Provisional application No. 62/581,286, filed on Nov. 3, 2017.

(51) Int. Cl. B28B 23/00; E03C 1/04

(52) U.S. Cl. CPC B28B 23/0025; C04B 41/0036; E03C 1/04; B28B 23/005

(57) ABSTRACT

A method of forming a faucet includes providing a waterway comprised of a polymeric material, supporting the waterway within a mold cavity formed with a shape of the faucet, overmolding a non-metallic material, such as a concrete material, onto the waterway within the mold cavity, and curing the concrete material.

### CROSS REFERENCE TO RELATED APPLICATION

This application claims priority to U.S. Provisional Patent Application Ser. No. 62/581,286, filed Nov. 3, 2017, the disclosure of which is hereby expressly incorporated by reference herein in its entirety.

### BACKGROUND OF THE DISCLOSURE

The present invention relates generally to a faucet and, more particularly, to a faucet at least partially formed of a non-metallic material, such as a concrete material.

Traditional faucets may be comprised of various metallic and/or polymeric materials. For example, the spout, handle, base, and any other visible component of the faucet may be comprised of a variety of polymeric and/or metallic materials in a plurality of finishes, colors, etc. Such materials are typically formed with an internal waterway for the faucet to deliver water from the water supply to the spout.

There is a need for a faucet which may be comprised of non-traditional materials. For example, users may prefer the look, design, and durability of a faucet formed from a composite material, such as concrete, a ceramic material, or another suitable non-metallic material.

### SUMMARY OF THE DISCLOSURE

According to an illustrative embodiment of the present disclosure, a method of forming a faucet comprises providing a waterway comprised of a polymeric material, supporting the waterway within a mold cavity formed with a shape of the faucet, overmolding a non-metallic material onto the waterway within the mold cavity, and curing the non-metallic material. The non-metallic material may be a concrete material.

According to another illustrative embodiment of the present disclosure, a method of forming a faucet comprises providing a waterway within a mold cavity, providing a mounting member within the mold cavity, overmolding a concrete material onto the waterway and the mounting member, forming the concrete material in a shape of the faucet, removing air within the concrete material, and curing the concrete material in the shape of the faucet.

According to yet another illustrative embodiment of the present disclosure, a method of forming a faucet comprises providing a waterway within a mold cavity, overmolding a concrete material onto the waterway, forming the concrete material in a shape of a spout portion and a hub portion of the faucet, moving the mold cavity to at least one of an angled position or an upside-down position, vibrating the mold cavity to remove air within the concrete material, curing the concrete material in the shape of the spout portion and the hub portion of the faucet, providing a surface treatment to the cured concrete material, and sealing the cured concrete material.

In a further illustrative embodiment of the present disclosure, a faucet comprises a waterway comprised of a polymeric material, a valve assembly fluidly coupled to the waterway, a spout body generally supporting a portion of the waterway, and a hub generally supporting the valve assembly. The spout body and the hub are comprised of a concrete material. Additionally, the spout body is overmolded with the portion of the waterway.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a front perspective view of an illustrative faucet of the present disclosure mounted on a sink deck;

FIG. 2 is a front perspective view of the faucet of FIG. 1;

FIG. 3A is a cross-sectional view of the faucet of FIG. 2, taken along line 3ABC-3ABC of FIG. 2, showing a portion of a waterway within a hub portion of the faucet;

FIG. 3B is a cross-sectional view of the faucet of FIG. 2, taken along line 3ABC-3ABC of FIG. 2, showing support members that may be used during a molding process;

FIG. 3C is a cross-sectional view of the faucet of FIG. 2, taken along line 3ABC-3ABC of FIG. 2, showing a mounting post for securing the faucet to the sink deck of FIG. 1;

FIG. 4 is a cross-sectional view of the faucet of FIG. 2, taken along line 4-4 of FIG. 2;

FIG. 5 is an exploded view of the faucet of FIG. 2;

FIG. 6 is an exploded view of the faucet of FIG. 2, including the waterway;

FIG. 7 is an exploded view of an illustrative handle assembly of the faucet of FIG. 2;

FIG. 8 is a schematic view of a mold assembly for manufacturing the faucet of FIG. 1; and

FIG. 9 is a flow diagram of an illustrative method of manufacturing the faucet of FIG. 1.

### DETAILED DESCRIPTION OF THE DRAWINGS

The embodiments of the invention described herein are not intended to be exhaustive or to limit the invention to precise forms disclosed. Rather, the embodiments selected for description have been chosen to enable one skilled in the art to practice the invention. Although the disclosure is described in connection with water, it should be understood that additional types of fluids may be used.

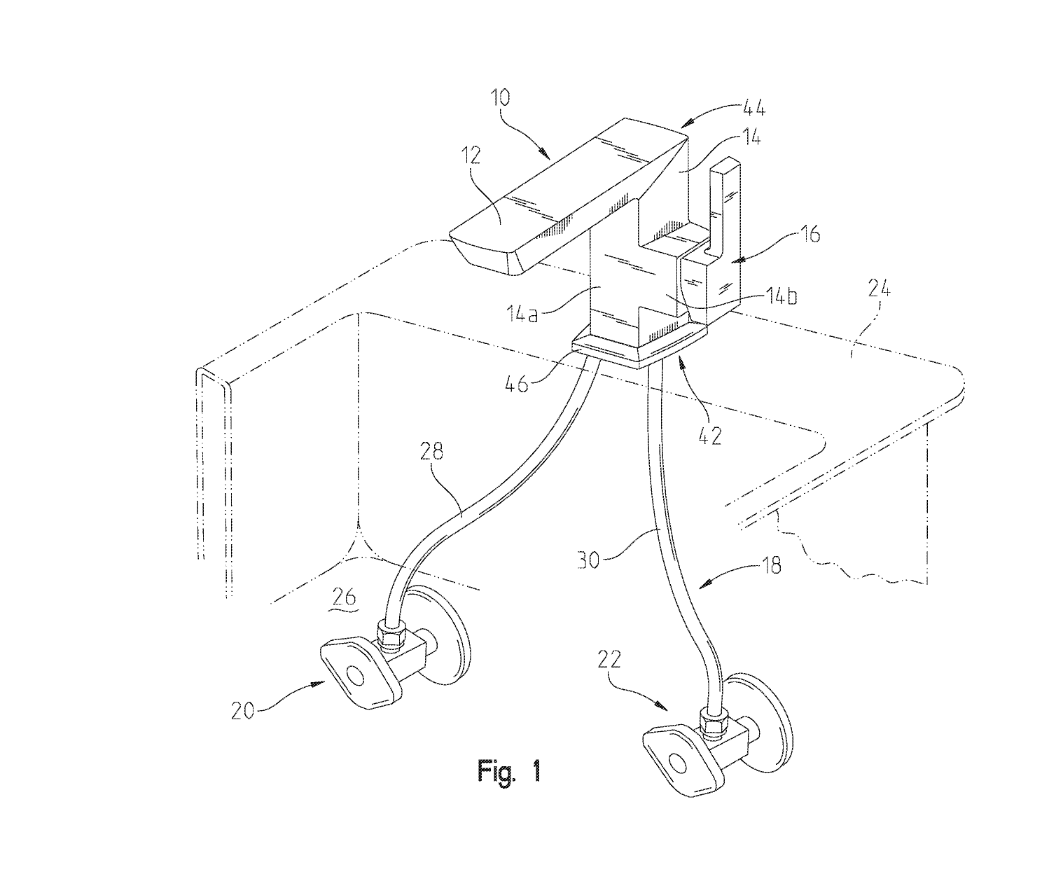

Referring to FIG. 1, an illustrative embodiment faucet 10 is shown including a spout body 12, a hub 14, a handle assembly 16, and a waterway assembly 18. In operation, faucet 10 receives water from a hot water supply 20 and a cold water supply 22 and mixes the incoming water to form an outlet stream. Faucet 10 may be mounted to a sink deck 24 or another suitable surface and may deliver the mixed outlet stream into a sink basin 26, for example.

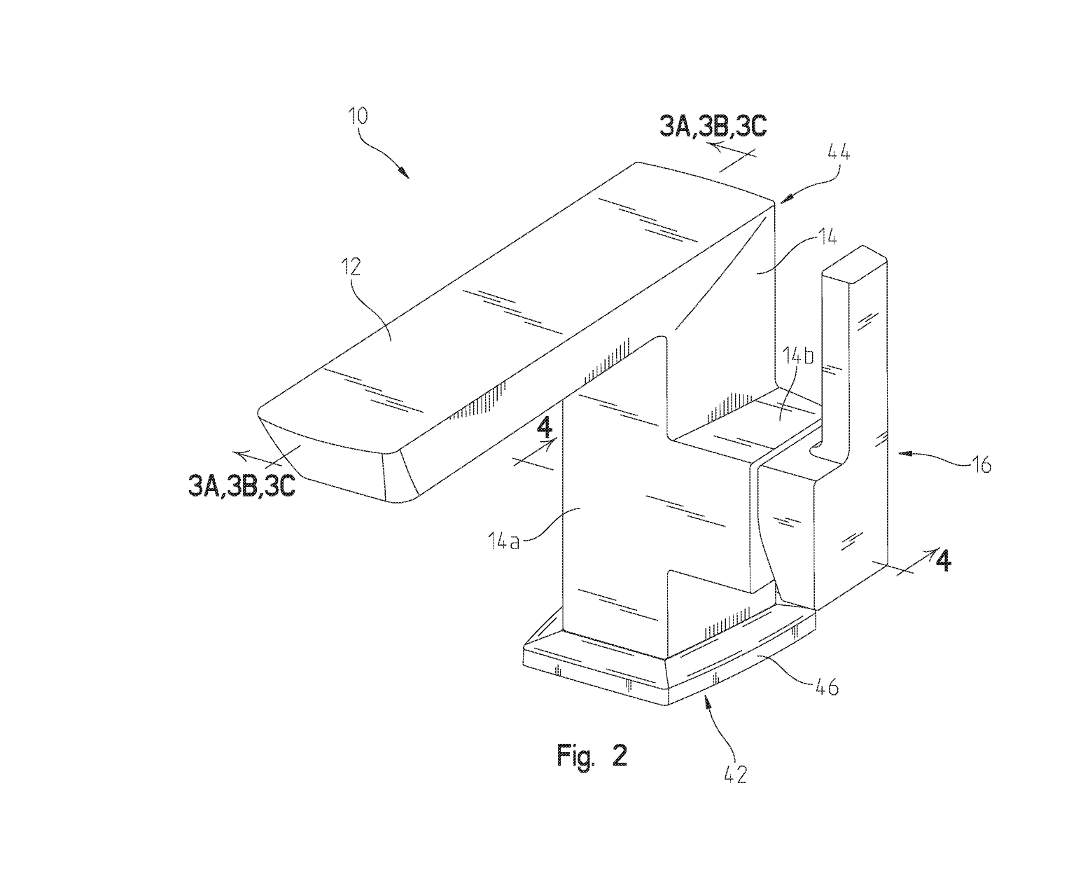

As shown in FIGS. 1-5, illustrative hub 14 of faucet 10 is a generally hollow component having a vertically disposed body portion 14a and a horizontally disposed valve portion 14b extending transversely therefrom. Body portion 14a of hub 14 includes an open lower end portion 42 that is configured to rest against sink deck 24 (FIG. 1) or other suitable surface. Body portion 14a of hub 14 also includes upper end portion 44 that is configured to couple with spout body 12. In one embodiment, body portion 14a of hub 14 is integrally formed with spout body 12.

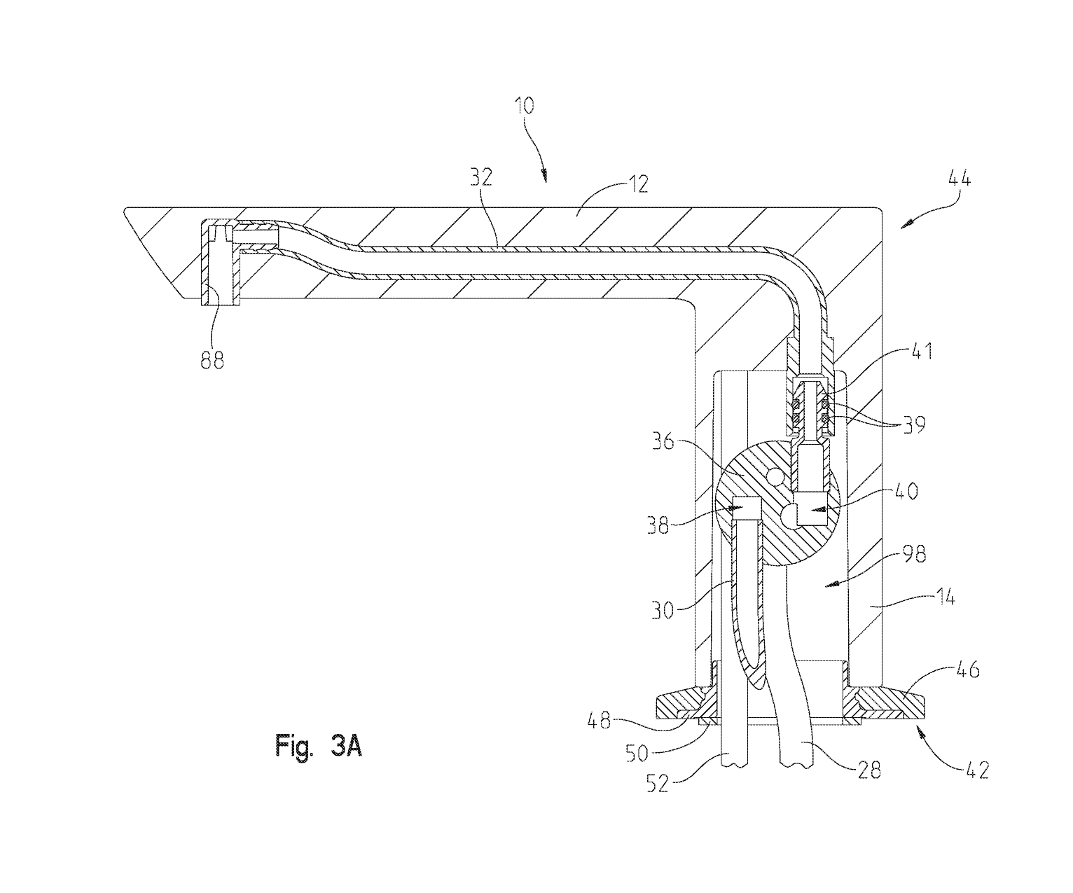

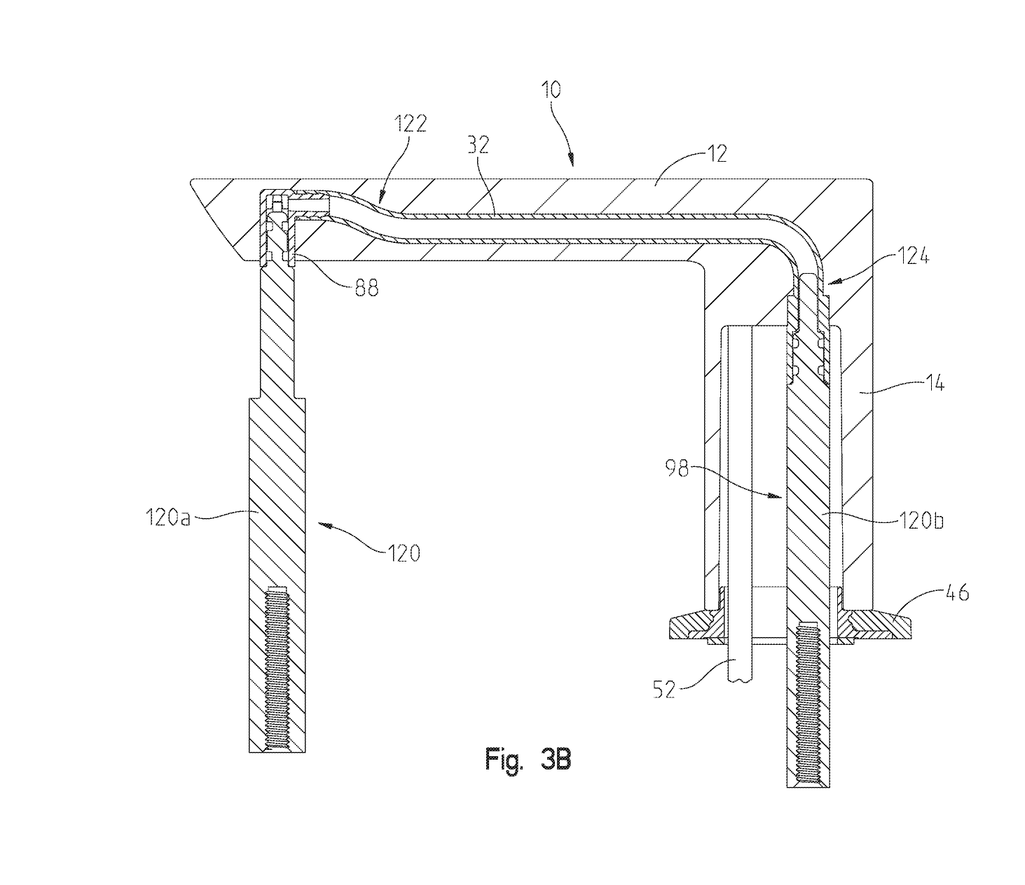

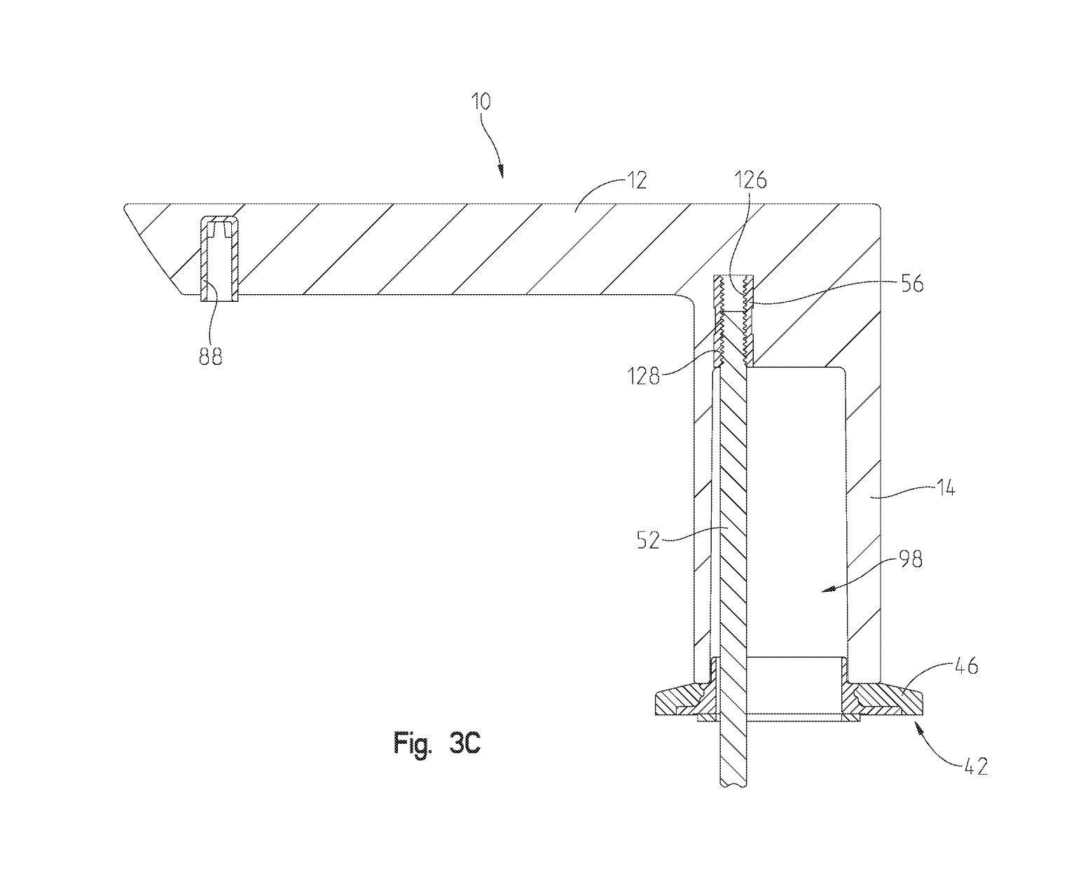

Referring still to FIGS. 1-5, in one embodiment, hub 14 includes and/or is coupled to a base or escutcheon member 46 which is positioned on sink deck 24. More particularly, and as shown best in FIG. 3A, escutcheon member 46 may be configured to conceal a mounting bracket 48 coupled to sink deck 24. Mounting bracket 48 may be a separate component from escutcheon member 46 and coupled thereto or may be integrally formed with escutcheon member 46. A sealing member 50, for example an o-ring, gasket, or any other seal, may be positioned intermediate sink deck 24 and mounting bracket 48.

As shown best in FIGS. 3A-5, hub 14 may further be mounted to sink deck 24 with a mounting rod, shank, or post 52. Mounting post 52 is configured to extend through an opening 54 in a waterway adapter 36 and is received within a portion of a mounting member 56, defined in one embodiment as a mounting nut. In one embodiment, an upper portion of mounting post 52 may be threaded and an internal portion of mounting member 56 also may be threaded. As such, mounting post 52 may be threadedly coupled to mounting member 56 within hub 14 in order to support hub 14 on sink deck 24, as shown in FIG. 3C. Illustratively, mounting member 56 may be defined by a hexagonal outer shape. The hexagonal shape thereof may prevent rotation of mounting post 52 and mounting member 56 within hub 14 to ensure that hub 14 is maintained in a predetermined position on sink deck 24. Alternatively, at a least a portion of hub 14 and/or spout body 12 may be configured for movement relative to escutcheon member 46 in various embodiments of faucet 10.

With reference still to FIGS. 1-5, illustrative waterway assembly 18 of faucet 10 includes a hot water inlet tube 28 fluidly coupled to hot water supply 20, a cold water inlet tube 30 fluidly coupled to cold water supply 22, and an outlet tube 32 (FIG. 3A). In one embodiment, outlet tube 32 defines the spout tube positioned within spout body 12, however, in alternative embodiments, outlet tube 32 may be positioned within hub 14 and fluidly coupled to a separate spout tube. Illustratively, waterway adapter 36 is supported within a portion of body portion 14a of hub 14 and includes first and second inlets 38 for receiving inlet tubes 28, 30 and an outlet 40 for receiving outlet tube 32. Outlet 40 may include a nipple or other coupling member 41 configured with at least one sealing member, illustratively o-rings 39, to couple outlet tube 32 to waterway adapter 36. Additional details of at least inlet tubes 28, 30 may be disclosed in U.S. Pat. No. 8,739,813, issued on Jun. 3, 2014, and entitled “WATERWAY FOR A SINGLE SUPPLY FAUCET” (Attorney Docket No. DFC-P4305), the complete disclosure of which is expressly incorporated by reference herein.

To limit contact between the water in faucet 10 and metallic components, waterway assembly 18 may be formed of a flexible, non-metallic material, such as a polymeric material, illustratively a cross-linkable polymer. As such, waterway assembly 18 is illustratively electrically non-conductive. In one illustrative embodiment, substantially the entire waterway assembly 18 (including tubes 28, 30, 32) is formed of a polyethylene which is subsequently cross-linked to form cross-linked polyethylene (PEX). Other suitable materials that may be used to construct waterway assembly 18 include polyethylene (PE) (such as raised temperature resistant polyethylene (PE-RT)), polypropylene (PP) (such as polypropylene random (PPR)), and polybutylene (PB). It is further envisioned that waterway assembly 18 may be constructed of cross-linked polyvinyl chloride (PVCX) using silane free radical initiators, cross-linked polyurethane, or cross-linked propylene (XLPP) using peroxide or silane free radical initiators. It is within the scope of the present disclosure that the polymer material used to construct waterway assembly 18 may include reinforcing members, such as glass fibers. Waterway assembly 18 may be constructed by the method set forth in International Patent Publication No. WO 2010/099397 to Nelson et al., filed Feb. 26, 2010, entitled “FAUCET MANIFOLD,” the disclosure of which is expressly incorporated by reference herein.

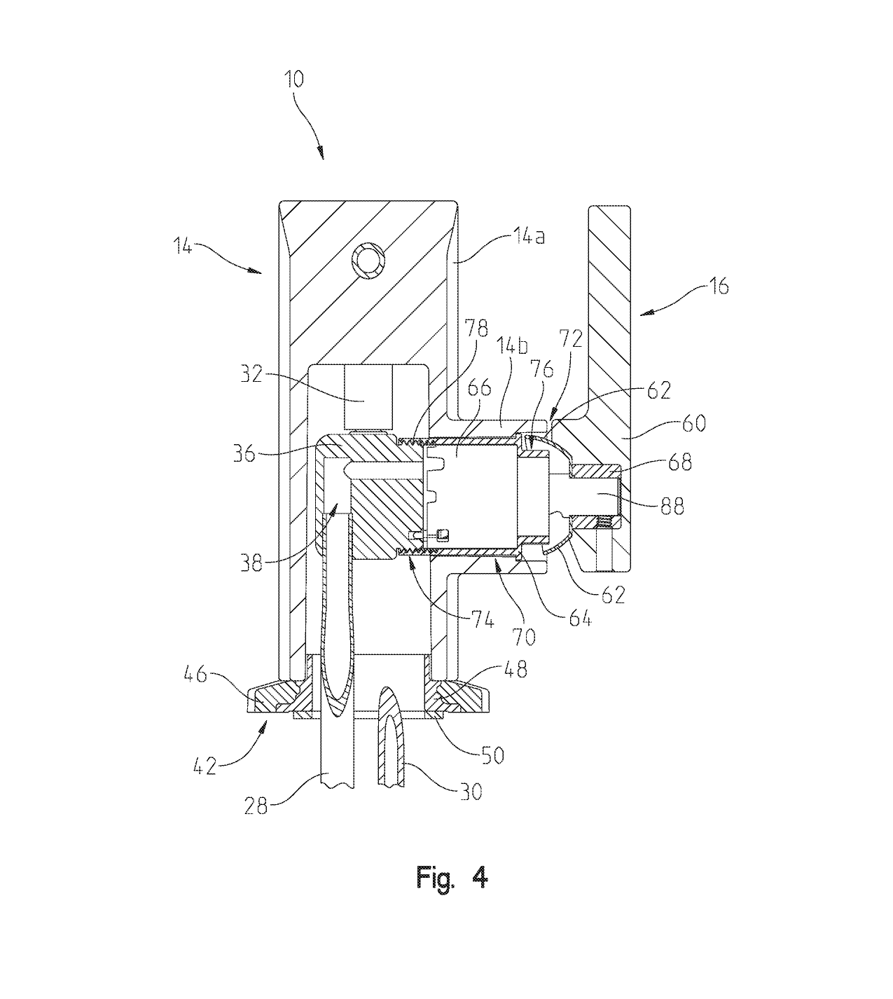

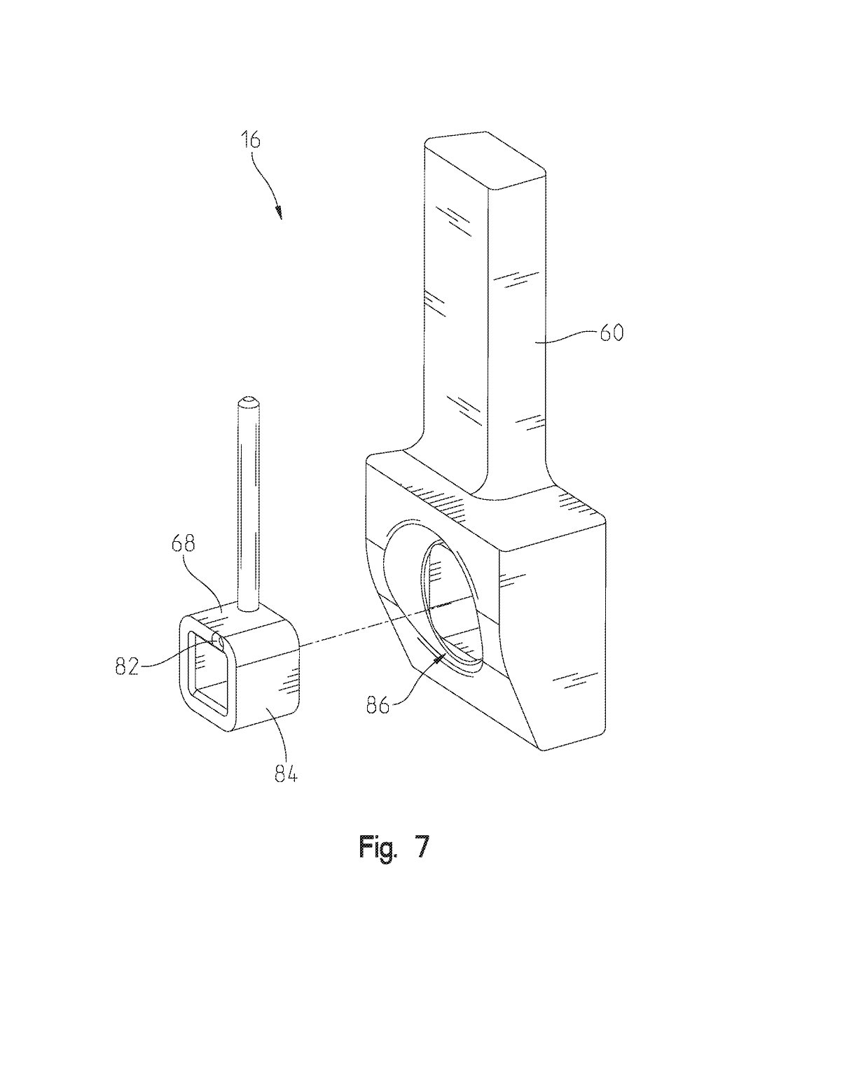

Referring to FIGS. 4, 5, and 7, handle assembly 16 of faucet 10 includes a handle 60, a handle adapter 68, and a valve assembly 70 comprising at least a bonnet 62, a sleeve 64, and a valve body 66 (FIG. 7). Valve assembly 70 is supported by valve portion 14b of hub 14 and is removably coupled to waterway adapter 36 located in body portion 14a of hub 14. In this illustrative embodiment, valve assembly 70 may be removed from an open end 72 of valve portion 14b of hub 14 for cleaning or servicing without having to remove waterway adapter 36 from body portion 14a of hub 14.

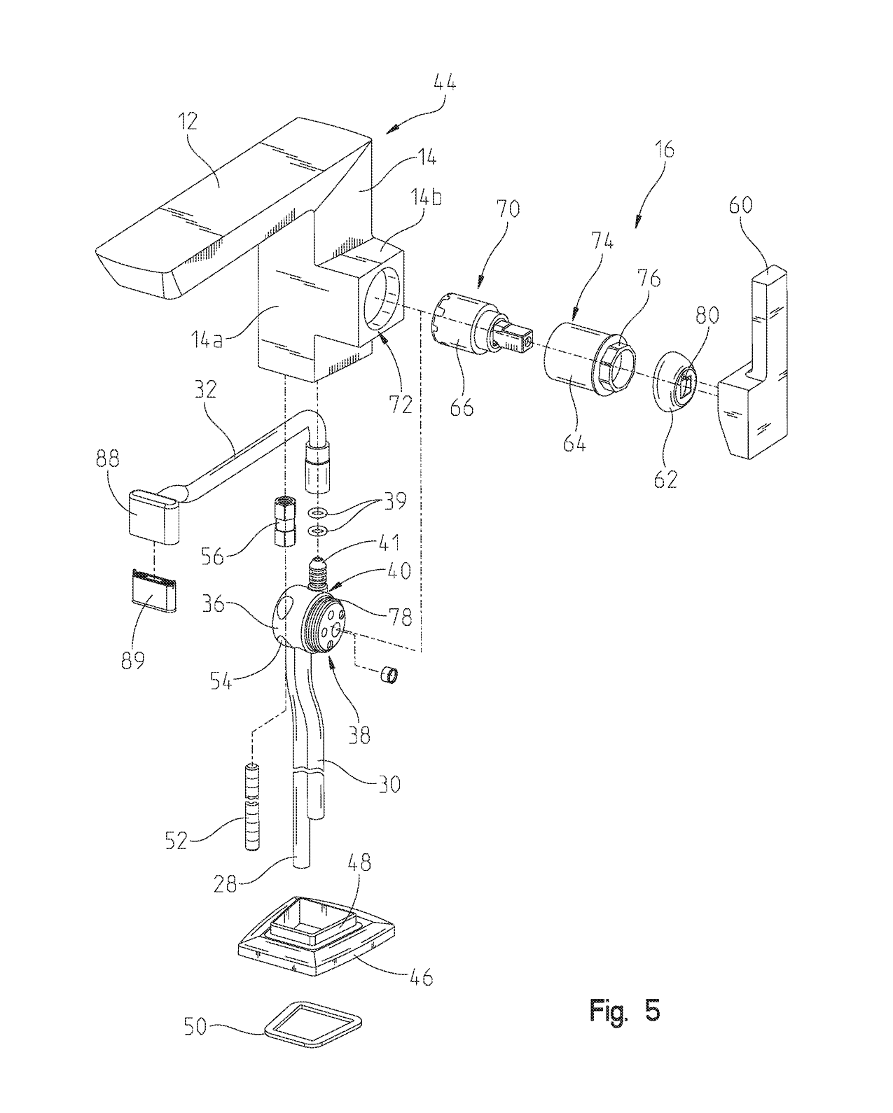

Sleeve 64 of the illustrative valve assembly 70 includes a first end 74 and a second end 76. In the illustrative embodiment of FIGS. 4 and 5, valve body 66 is removably coupled to waterway adapter 36 by fitting sleeve 64 over valve body 66 and coupling first end 74 of sleeve 64 with an end portion 78 of waterway adapter 36. As shown in FIG. 4, sleeve 64 forces valve body 66 against waterway adapter 36 and is configured to reduce leakage between waterway adapter 36 and sleeve 64. Bonnet 62 may then be coupled with second end 76 of sleeve 64 for receiving handle 60 thereon.

One or more locating elements, illustratively a pin 80 of FIG. 5, extends from bonnet 62 to assist with coupling handle 60 to valve assembly 70 at open end 72 of valve portion 14b of hub 14. As shown in FIGS. 5 and 7, pin 80 extends from a laterally-outer portion of bonnet 62 and is received within a locating opening 82 on adapter 68. As is detailed further herein, adapter 68 is positioned within a portion of handle 60 and a body portion 84 of adapter 68, which includes locating opening 82, may be exposed through an opening 86 of handle 60. As such, pin 80 of bonnet 62 is received within locating opening 82 of body portion 84 of adapter 68 to correctly position handle 60 on valve portion 14b of hub 14.

Illustratively, valve assembly 70 may be a conventional mixing valve assembly which is operated by adjusting handle 60 to control the mixing of hot and cold water and the flow rate of water through valve body 66. More particularly, because waterway assembly 18 is in fluid communication with valve body 66 via waterway adapter 36, adjusting handle 60 allows a user to selectively vary the temperature and flow rate of water supplied to outlet tube 32 of waterway assembly 18 from hot and cold water inlet tubes 28, 30 of waterway assembly 18. In one embodiment, illustrative valve assembly 70 may be of a movable disc variety, however, it should be appreciated that other types of valve assemblies may be substituted therefor. For example, a ball-type mixing valve assembly may find equal applicability with the present invention. Additional details of valve assembly 70 may be disclosed in U.S. Pat. No. 7,753,074, issued on Jul. 13, 2010, and entitled “MIXING VALVE” (Attorney Docket No. DFC-P0049), the complete disclosure of which is expressly incorporated by reference herein.

In use, hot and cold water flows from hot and cold water supplies 20, 22 to valve assembly 70 of faucet 10. More particularly, hot water flows from hot water supply 20 to valve assembly 70 via hot water inlet tube 28 of waterway assembly 18 and cold water flows from cold water supply 22 to valve assembly 70 via cold water inlet tube 30 of waterway assembly 18. Then, the hot and cold inlet water streams are mixed and redirected in valve assembly 70. The mixed outlet water stream flows from outlet 40 of waterway adapter 36, into outlet tube 32 of waterway assembly 18, and toward sink basin 26 from spout body 12.

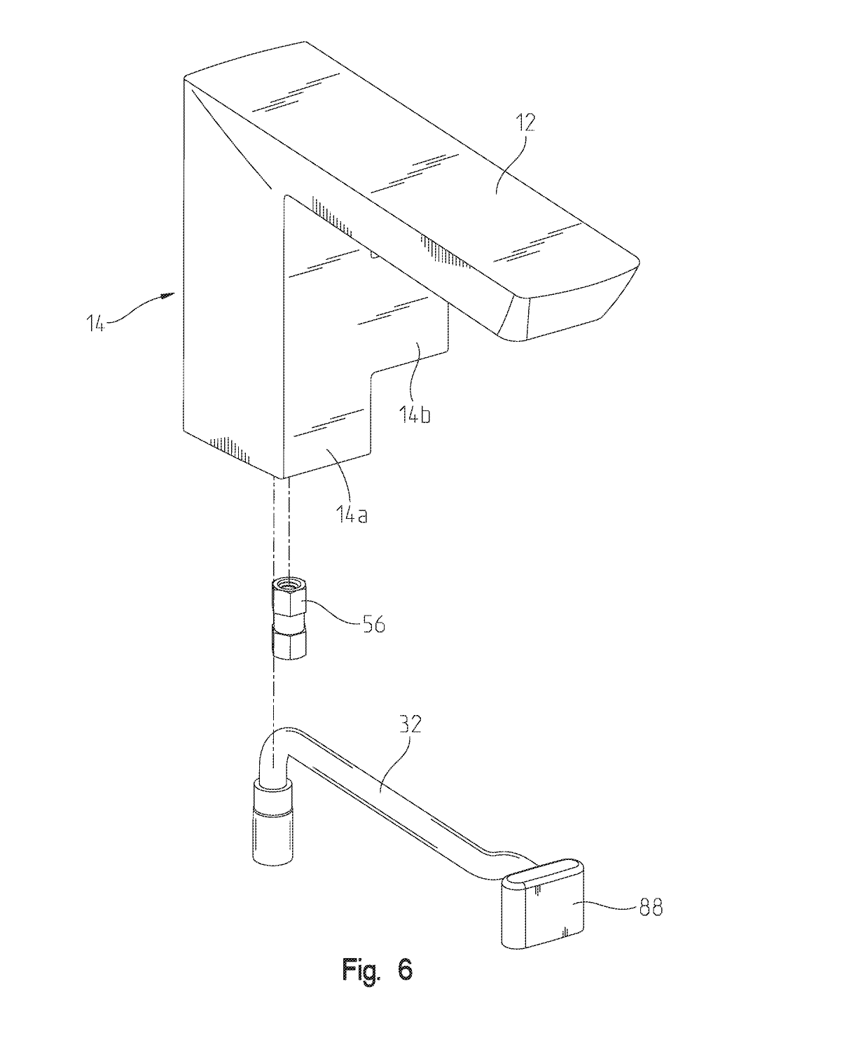

To facilitate proper fluid flow from outlet tube 32 and toward sink basin 26, outlet tube 32 may include an aerator housing 88 configured to support an aerator member 89 (FIG. 5). Illustratively, and referring to FIGS. 3A, 5, and 6, aerator housing 88 may be removably coupled to outlet tube 32, however, in other embodiments, aerator housing 88 may be integrally formed with outlet tube 32. Aerator housing 88 is configured to receive aerator member 89 therein to allow for a smooth stream of water flow from outlet tube 32.

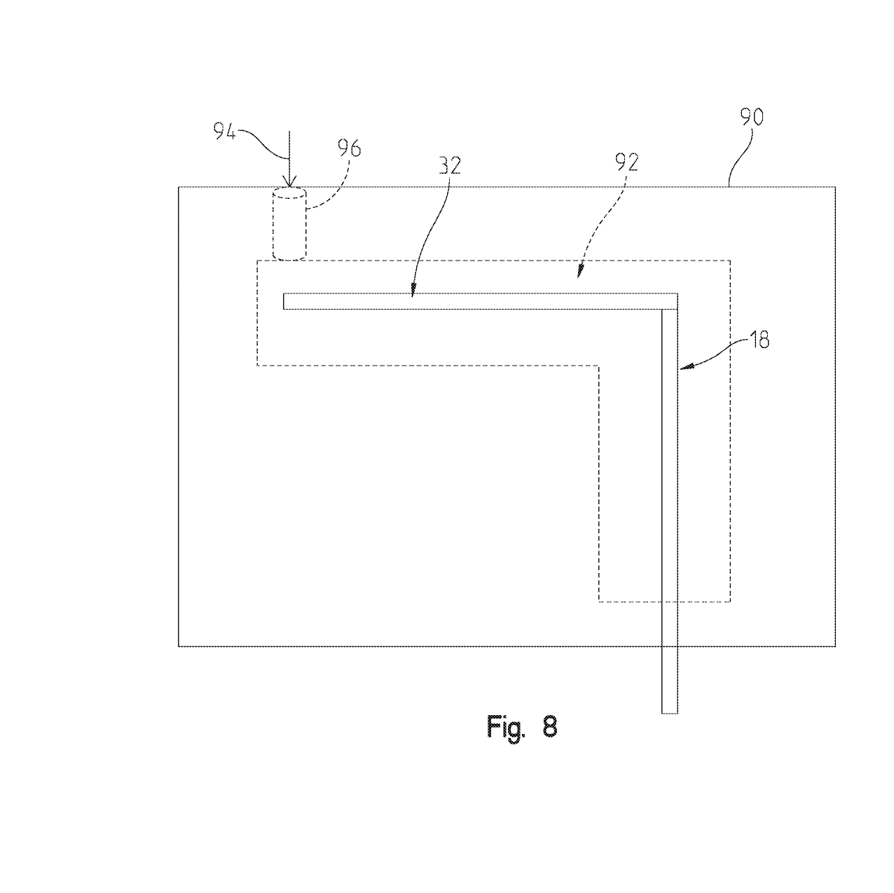

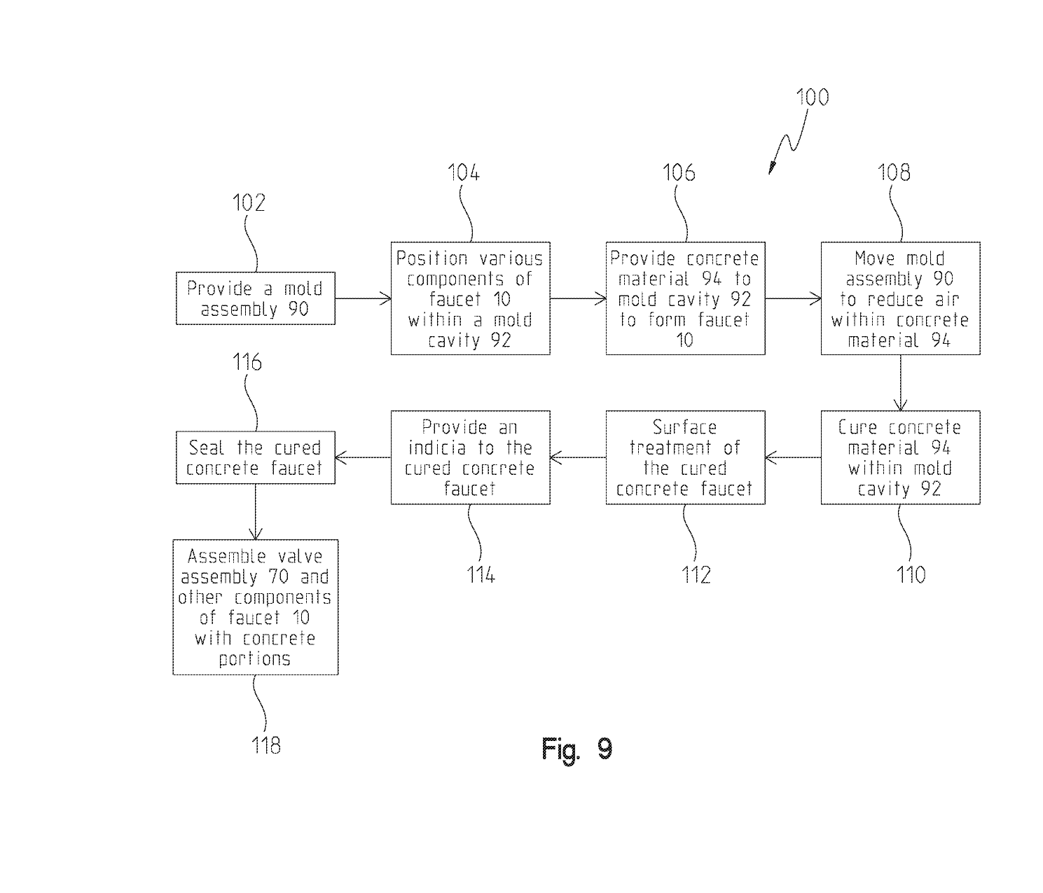

As disclosed further herein, and referring now to FIGS. 8 and 9, various components of faucet 10 may be comprised of a non-metallic material and, more particularly, of a composite material, such as concrete, a ceramic material, or another suitable non-metallic material. For example, at least spout body 12 and hub 14 may be comprised of the concrete material. In other embodiments, handle 60 and/or escutcheon member 46 also may be comprised of the concrete material. As such, outer or visible components and surfaces of faucet 10 may provide the aesthetic and structural benefits of the concrete material, whereas various concealed components, such as waterway assembly 18 and valve assembly 70, may be comprised of polymeric materials for inhibiting contaminants from entering the water.

In one embodiment, the concrete material is shown as 94 in FIG. 8 and may be an ultra-high-strength concrete material. Concrete material 94 may include an aggregate bound together with cement, such as ceramic cement. Concrete material 94 may also include fibers, such as polyvinyl alcohol (“PVA”) fibers, mixed therein. However, concrete material 94 forming at least spout body 12 and hub 14 does not include any metallic material therein. More particularly, concrete material 94 of spout body 12 and hub 14 does not include any rebar, other metal reinforcement members, metal fillers, or any other type of metallic material therein. This omission of metallic material within concrete material 94 eliminates any concern that thermal expansion of a metallic material within concrete material 94 would cause internal cracking of deformations of concrete material 94. Therefore, by omitting any metallic material within concrete material 94, the likelihood of cracking or other structure deformations within concrete material 94 is reduced.

As shown in FIGS. 8 and 9, faucet 10 may be formed according to method 100 (FIG. 9). Illustratively, a mold assembly 90 having an interior open mold cavity 92 may be provided in step 102 of method 100. Mold assembly 90 may be defined as a single member or may include a plurality of members or components, at least one of which is configured to move relative to the other members. For example, mold assembly 90 may include an upper portion and a lower portion, where the upper portion is configured to move between open and closed positions relative to the lower portion to expose mold cavity 92. As shown in FIG. 8, mold cavity 92 may be defined in the shape of at least a portion of faucet 10 such that mold cavity 92 defines an interior, open volume in the shape of at least spout body 12 and hub 14 (FIG. 1). Mold assembly 90 may further include separate cavities or portions of mold cavity 92 formed in the shape of handle 60 and/or escutcheon member 46 such that at least spout body 12, hub 14, handle 60, and/or escutcheon member 46 each may be comprised of concrete material 94.

Method 100 also includes step 104, in which at least a portion of waterway assembly 18 is positioned within mold cavity 92 of mold assembly 90. More particularly, portions of waterway assembly 18 may be pre-formed such that at least outlet tube 32 and aerator housing 88 (FIG. 5) are positioned within mold cavity 92. Additionally, in various embodiments, waterway adapter 36 and inlet tubes 28, 30 of waterway assembly 18 also may be positioned within mold cavity 92 in step 104. In such instances, portions of inlet tubes 28, 30, such as the lower end portions thereof, may extend outwardly from mold cavity 92 in order to be accessible for coupling with water supplies 20, 22 (FIG. 1). Alternatively, inlet tubes 28, 30 may not be coupled with waterway adapter 36 during the molding process and, instead, may be coupled thereto after faucet 10 is formed of concrete material 94, as disclosed herein.

It may be appreciated that mold assembly 90 may include support members 120 (FIG. 3B) positioned within a portion of mold cavity 92 to maintain the position of waterway assembly 18 therein during manufacturing method 100. In one embodiment, such support members 120 may be pins or plugs used to maintain the position of waterway assembly 18 within mold cavity 92.

Illustratively, as shown in FIG. 3B, support members 120 include a first support member 120a and a second support member 120b, both of which are configured to extend in a generally vertical direction. More particularly, first support member 120a is configured to extend towards aerator housing 88 positioned within mold cavity 92 such that an upper end of first support member 120a is received within aerator housing 88 to plug the opening thereof thereby ensuring that concrete material 94 does not enter aerator housing 88 or outlet tube 32 during molding process 100. First support member 120a also may support and maintain the position of aerator housing and a distal end 122 of outlet tube 32 within mold cavity 92.

Referring still to FIG. 3B, second support member 120b is configured to extend towards a proximal end 124 of outlet tube 32 such that an upper end of second support member 120b is received within proximal end 124 to plug the opening thereof, thereby ensuring that concrete material 94 does not enter outlet tube 32 during molding process 100. Second support member 120b also may support and maintain the position of outlet tube 32 within mold cavity 92 during molding process 100. In this way, the combination of first and second support members 120a, 120b prevents injection of concrete material 94 into outlet tube 32 during molding process 100.

Additionally, step 104 also may include providing adapter 68 of handle assembly 16 to a portion of mold cavity 92. More particularly, when handle 60 is comprised of concrete material 94, adapter 68 may be positioned within a portion of mold cavity 92 or within a second mold cavity (not shown) of mold assembly 90 such that adapter 68 may be overmolded with concrete material 94, as disclosed further herein. Adapter 68 may increase the strength and/or rigidity of handle 60. In this way, all components of faucet 10 which are to be overmolded with concrete material 94 are positioned with mold cavity 92 and/or another portion of mold assembly 90 before concrete material 94 is introduced therein.

Also, escutcheon member 46 may be comprised of concrete material 94 and, as such, mold assembly 90 may include a separate/third cavity in the shape of escutcheon member 46 and/or may include a portion of mold cavity 92 in the shape of escutcheon member 46. In this way, method 100 provides for multiple components of faucet 10 to be comprised of concrete material 94, such as spout body 12, hub 14, handle 60, and escutcheon member 46.

Further, and still referring to step 104, mounting member 56 may be provided within a portion of mold cavity 92 to overmold mounting member 56 with concrete material 94, as shown in FIG. 3C. More particularly, mounting member 56 is positioned within mold cavity 92 at an approximate interface of where spout body 12 will be molded with hub 14. Mounting member 56 includes internal threads 126 and may be threadedly or otherwise coupled to a support member (not shown) to prevent concrete material 94 from entering mounting member 56 during molding process 100. As such, the opening of mounting member 56 remains clear for eventual coupling with mounting post 52 to secure faucet 10 on sink deck 24, as disclosed herein. Illustratively, the upper end of mounting post 52 includes external threads 128 configured to threadedly couple with internal threads 126 of mounting member 56 when securing faucet 10 to sink deck 24.

In step 106 of method 100, concrete material 94 is provided to mold cavity 92 through at least one port 96 (FIG. 8). Alternatively, if mold assembly 90 is an open mold assembly, then concrete material 94 may be poured or otherwise provided to mold cavity 92 through an open upper surface of mold assembly 90, rather than through a port, such as port 96. Illustratively, mold assembly 90 is shown with a single port 96, however, mold assembly 90 may have any number of ports 96 and port(s) 96 may be positioned at any location on mold assembly 90. During step 106, concrete material 94 has a viscosity which allows for rapid pouring or injection thereof into mold cavity 92. Because mold cavity 92 is defined by the shape of faucet 10, when concrete material 94 is provided to mold cavity 92 in step 106, concrete material 94 is configured to form at least portions of faucet 10.

Referring still to FIGS. 8 and 9, step 108 of method 100 includes moving mold assembly 90 in various methods and manners to remove any air pockets or bubbles within concrete material 94. For example, mold assembly 90 may be vibrated (e.g., with a vibrating table) to encourage movement of any trapped air bubbles toward the outer surfaces of concrete material 94. In addition to, or instead of, vibrating mold assembly 90, mold assembly 90 may be moved to an upside-down position and/or an angled position. More particularly, mold assembly 90 may be moved to an upside-down position such that all air bubbles within concrete material flow towards the downward surface of mold cavity 92 in this position and are released from the surface of concrete material in the downward position. Additionally, mold assembly 90 may be moved to a position which is angled relative to vertical and/or horizontal to encourage the flow of any trapped air bubbles within concrete material 94 toward a single surface or location. In one embodiment, when in the angled position, mold assembly 90 may be vibrated to move the air pockets or bubbles, also called bug-holes, toward a gate area of mold assembly 90, such that the gate (including the air bubbles) may be cut off. By flowing any trapped air bubbles towards a single surface or location of concrete material 94 within mold cavity 92, the air bubbles may be released or removed from the surface of concrete material 94 before the material is cured, thereby ensuring that concrete material 94 does not include any air bubbles or pockets when formed into faucet 10.

Step 110 of method 100 includes curing concrete material 94 within mold cavity 92 to form at least various portions of faucet 10, such as spout body 12, hub 14, handle 60, and/or escutcheon member 46. Concrete material 94 is configured to cure at room temperature, thereby eliminating the need for external heat during the curing process. In this way, there is no concern that any portion of waterway assembly 18 which is overmolded with concrete material 94 would be damaged (e.g., melted) by any external heat. In embodiments where the curing temperature of step 110 exceeds room temperature, waterway assembly 18 may be formed of a material that is capable of withstanding the elevated curing temperature.

Because mold cavity 92 defines a continuous open volume in the shape of spout body 12 and hub 14, spout body 12 and hub 14 may be integrally formed together of concrete material 94. Additionally, escutcheon member 46, if formed of concrete material 94, may be separately formed from hub 14 or may be integrally formed with hub 14. Handle 60, if formed of concrete material 94, is not integral with hub 14 to ensure that handle 60 is configured to rotate relative thereto. Further, because at least spout body 12 is overmolded with outlet tube 32 but is entirely formed of concrete material 94, spout body 12 does not merely provide a concrete cover for an internal passageway into which outlet tube 32 is later inserted, but rather, is entirely formed of concrete material 94 and forms passageways for water flow therethrough by overmolding concrete material 94 with outlet tube 32. Similarly, hub 14 is entirely comprised of concrete material except for any components overmolded or otherwise provided therein and/or any recesses configured to receive components of faucet 10.

Referring still to FIGS. 8 and 9, step 112 of method 100 includes providing a surface treatment to the cured concrete material 94. For example, the outer surface of the cured concrete material 94, when formed in the shape of spout body 12 and hub 14, may be sanded to provide a smooth finish to concrete material 94. In another embodiment, the outer surface of the cured concrete material 94, when formed in the shape of spout body 12 and hub 14, may be sand-blasted to provide a textured finish or surface to concrete material 94. Step 112 may be provided for various aesthetic benefits to the overall look of faucet 10 and/or may be provided to remove any impurities, deformities, surface roughness, or other such concern that may affect the outer surface of the cured concrete material 94.

Next, in step 114 of method 100, indicia (not shown) may be provided to the cured concrete material 94. For example, a logo, an identification number, a company name, a brand name, personalized identification symbol or letters, or any other type of alphanumeric character(s) or information may be provided on an outer surface thereof. For example, a logo may be provided on an inner surface of hub 14 which faces sink basin 26 (FIG. 1). In one embodiment, the indicia is provided on the surface of cured concrete material 94 through an etching process and, more particularly, may be provided through a laser-etching process.

Method 100 also includes step 116 which provides for sealing the outer surface of faucet 10. The outer surface of cured concrete material 94 may be sealed with a concrete sealant (not shown) through any known process, such as dipping faucet 10 into a sealant bath. Sealing step 116 allows the sealant material to deeply penetrate or impregnate cured concrete material 94 which may prevent moisture from flowing into concrete material 94 and/or prevent concrete material 94 from staining. Additionally, either in in addition to or in lieu of the sealant material, a coating material (not shown) may be applied to cured concrete material 94 to also prevent moisture from entering concrete material 94 and staining.

At the conclusion of step 116, method 100 includes step 118 which is a final assembly step to couple valve assembly 70, remaining components of waterway assembly 18, and handle 60 to faucet 10 formed through steps 102-116. For example, hub 14 may be molded with an open recess or cavity 98 (FIG. 3) which is configured to receive additional components of faucet 10, such as waterway adapter 36, portions of valve assembly 70, etc. In this way, at the conclusion of step 118, faucet 10 is fully assembled and is configured for use on sink deck 24, as disclosed herein.

Faucet 10 may then be coupled with sink deck 24 through mounting bracket 48 and mounting post 52 such that open lower end portion 42 of hub 14 is positioned over mounting bracket 48 and post 52 is threadedly coupled with mounting member 56 molded into a portion of hub 14 during step 106 of method 100. Additionally, either during method 100 or after step 118 is complete, aerator member 89 may be positioned within aerator housing 88.

It may be understood that any open cavities of outlet tube 32, aerator housing 88, inlet tubes 28, 30, waterway adapter 36, mounting member 56, or any other component overmolded with concrete material 94 may include a removable plug therein to prevent concrete material 94 from entering any internal cavities defining waterway passages, coupling orifices, etc.

Although the invention has been described in detail with reference to certain preferred embodiments, variations and modifications exist within the spirit and scope of the invention as described and defined in the following claims.

1. A method of forming a faucet, comprising:
providing a waterway comprised of a polymeric material;
supporting the waterway within a mold cavity formed with a shape of the faucet;
overmolding a non-metallic material onto the waterway within the mold cavity; and
curing the non-metallic material.

2. The method of claim 1, wherein the non-metallic material is a concrete material.

3. The method of claim 2, further comprising positioning the mold cavity in an upside-down position before curing the concrete material.

4. The method of claim 2, further comprising moving the mold cavity to an angled position before curing the concrete material.

5. The method of claim 4, further comprising vibrating the mold cavity after moving the mold cavity to the angled position.

6. The method of claim 2, further comprising forming indicia onto a portion of the cured concrete material.

7. The method of claim 6, wherein forming the indicia includes laser etching the indicia into the portion of the cured concrete material.

8. The method of claim 6, wherein the indicia includes at least one of a logo, an identification number, an identification name, or an alphanumeric character.

9. The method of claim 2, further comprising sealing the cured concrete material.

10. The method of claim 2, further comprising providing a surface texture to the cured concrete material.

11. The method of claim 10, wherein providing the surface texture includes at least one of sanding the cured concrete material or sand-blasting the cured concrete material.

12. The method of claim 2, further comprising forming a handle of the faucet of the concrete material.

13. A method of forming a faucet, comprising:
providing a waterway within a mold cavity;
providing a mounting member within the mold cavity;
overmolding a concrete material onto the waterway and the mounting member;
forming the concrete material in a shape of the faucet;
removing air within the concrete material; and
curing the concrete material in the shape of the faucet.

14. The method of claim 13, wherein removing air within the concrete material includes vibrating the mold cavity before curing the concrete material.

15. The method of claim 13, wherein removing air within the concrete material includes positioning the mold cavity at an angle.

16. The method of claim 13, wherein removing air within the concrete material includes moving the mold cavity to an upside-down position.

17. The method of claim 13, further comprising coupling the mounting member with an external support member configured to support the faucet at a sink deck.

18. The method of claim 13, further comprising coupling an aerator to the faucet after curing the concrete material.

19. A method of forming a faucet, comprising:
providing a waterway within a mold cavity;
overmolding a concrete material onto the waterway;
forming the concrete material in a shape of a spout portion and a hub portion of the faucet;
moving the mold cavity to at least one of an angled position or an upside-down position;
vibrating the mold cavity to remove air within the concrete material;
curing the concrete material in the shape of the spout portion and the hub portion of the faucet;
providing a surface treatment to the cured concrete material; and
sealing the cured concrete material.

20. The method of claim 19, further comprising forming a base for the faucet of the concrete material.

21. The method of claim 19, further comprising forming a handle for the faucet of the concrete material.

22. The method of claim 19, wherein the concrete material includes non-metallic materials.

23. A faucet, comprising:
a waterway comprised of a polymeric material;
a valve assembly fluidly coupled to the waterway;
a spout body generally supporting a portion of the waterway; and
a hub generally supporting the valve assembly, and the spout body and the hub are comprised of a concrete material, and the spout body is overmolded with the portion of the waterway.

24. The faucet of claim 23, further comprising a handle operably coupled to the valve assembly and comprised of the concrete material.

25. The faucet of claim 24, wherein the handle includes an adapter comprised of a non-concrete material, and the adapter is overmolded with the concrete material.

26. The faucet of claim 23, wherein the concrete material includes non-metallic materials.
